(19) United States
(12) Patent Application Publication
(10) Pub. No.: US 2015/0239100 A1
(43) Pub. Date: Aug. 27, 2015

(54) FASTENER STRUCTURE FOR PLIERS

(71) Applicant: LI-TU WU, Taichung city (TW)

(72) Inventor: LI-TU WU, Taichung city (TW)

(21) Appl. No.: 14/188,691

(22) Filed: Feb. 25, 2014

(51) Int. Cl. B25B 7/14; B25B 7/06

(52) U.S. Cl. CPC B25B 7/14; B25B 7/06

(57) ABSTRACT

A fastener structure for pliers contains a first plier part, a second plier part, and a slidable fastener. The first plier part is pivotally connected with the second plier part to form two handle segments and two operating segments of the first plier part and the second plier part. The first plier part includes a fixing mount disposed on a handle segment thereof adjacent to a connecting portion of the first plier part and the second plier part and includes at least one guiding rail formed on the fixing mount. The second plier part includes a retaining seat mounted on a handle segment thereof proximate to the connecting portion of the first plier part and the second plier part. The slidable fastener includes at least one guide protrusion for retaining with the at least one guiding rail and includes a positioning rib for limiting or releasing the retaining seat.

### FIELD OF THE INVENTION

The present invention relates to a fastener structure for pliers which is provided with a slidable fastener for releasing or limiting an expansion and a retraction of a first plier part and a second plier, thus retracting and fixing two operating segments safely.

### BACKGROUND OF THE INVENTION

A conventional clamp pliers or cut pliers is comprises of two plier parts pivotally connected together so as so form two griping segments and two clamping segments. In operation, one of the two griping segments is held by user's thumb and web between the thumb and forefinger, and the other griping segment is held by the other fingers, thus pressing and expanding the clamp pliers or the cut pliers. However, after clamping the two clamping segments, the two griping segments are expanded troublesomely. To overcome such a problem, a resilient element is defined between the two griping segments so as to provide returning elasticity to expand the two griping segments automatically.

To avoid the two clamping segments injuring the user, a retainer is fixed on a distal ends of the pliers, but such a configuration will cause operating inconvenience. For instance, the user has to release, retract or swift the retainer with the other hand.

The present invention has arisen to mitigate and/or obviate the afore-described disadvantages.

### SUMMARY OF THE INVENTION

The primary objective of the present invention is to provide a fastener structure for pliers which is provided with a slidable fastener for releasing or limiting an expansion and a retraction of a first plier part and a second plier, thus retracting and fixing two operating segments safely.

Another objective of the present invention is to provide a fastener structure for pliers in which two outer walls of the slidable fastener are higher than two handle segments so that a user pushes the slidable fastener easily to release or limit the pliers.

To obtain the above objectives, a fastener structure for pliers provided by the present invention contains: a first plier part, a second plier part, and a slidable fastener.

The first plier part is pivotally connected with the second plier part so as to form two handle segments and two operating segments of the first plier part and the second plier part.

The first plier part includes a fixing mount disposed on an inner surface of a handle segment thereof adjacent to a connecting portion of the first plier part and the second plier part and includes at least one guiding rail formed on the fixing mount.

The second plier part includes a retaining seat mounted on an inner surface of a handle segment thereof proximate to the connecting portion of the first plier part and the second plier part.

The slidable fastener includes at least one guide protrusion for slidably retaining with the at least one guiding rail and includes a positioning rib for limiting or releasing the retaining seat.

Preferably, two guiding rails are formed on two sides of the fixing mount, the slidable fastener includes a hollow cavity defined between two inner walls thereof so as to retain the slidable fastener with the fixing mount, and the slidable fastener further includes two guide protrusions formed on the two inner walls thereof.

Preferably, the retaining seat has two first bosses arranged on two sides thereof, and the slidable fastener further includes two locking ribs formed on the two inner walls thereof so as to retain with the two first bosses, the retaining seat also has a slot defined between the two sides thereof so as to separate the two first bosses.

Preferably, each guiding rail has a limiting recess and a releasing recess defined on an inner surface thereof, and each guide protrusion has a second boss for retaining with the limiting recess or the releasing recess.

Preferably, the retaining seat further has a tilted face defined on a bottom end thereof, and the positioning rib has an arcuate face formed on a top end thereof so as to be pushes by the tilted face to drive the slidable fastener to slide downwardly.

### BRIEF DESCRIPTION OF THE DRAWINGS

FIG. 1 is a perspective view showing the exploded components of a fastener structure for pliers according to a preferred embodiment of the present invention.

FIG. 2 is a perspective view showing the assembly of the fastener structure for the pliers according to the preferred embodiment of the present invention.

FIG. 3 is a cross sectional view showing the operation of the fastener structure for the pliers according to the preferred embodiment of the present invention.

FIG. 4 is a perspective view showing the operation of a part of the fastener structure for the pliers according to the preferred embodiment of the present invention.

FIG. 5 is another perspective view showing the operation of a part of the fastener structure for the pliers according to the preferred embodiment of the present invention.

FIG. 6 is also another perspective view showing the operation of a part of the fastener structure for the pliers according to the preferred embodiment of the present invention.

### DETAILED DESCRIPTION OF THE PREFERRED EMBODIMENTS

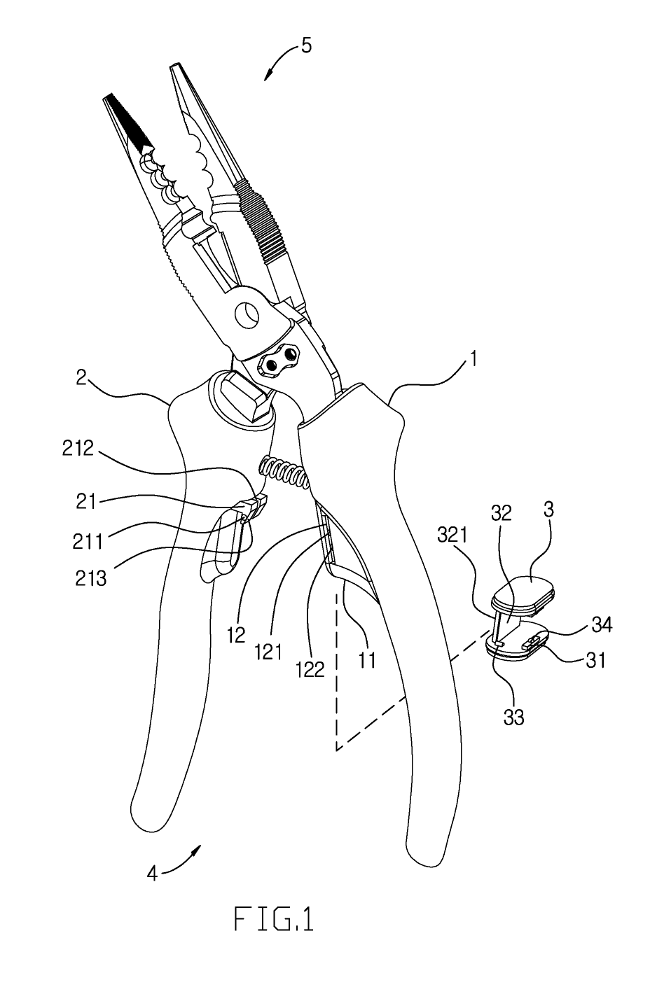

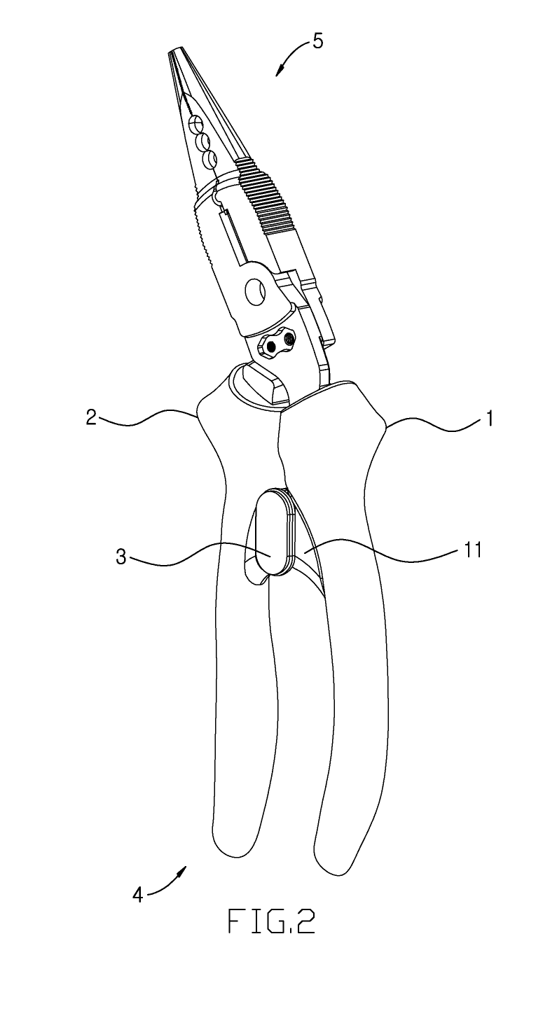

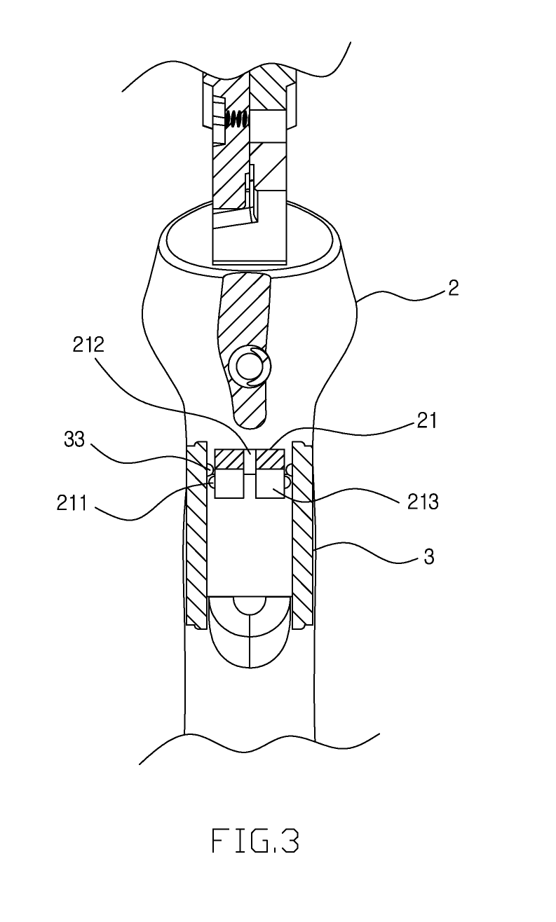

With reference to FIGS. 1-6, a fastener structure for pliers according to a preferred embodiment of the present invention comprises: a first plier part 1, a second plier part 2, and a slidable fastener 3. The first plier part 1 is pivotally connected with the second plier part 2 so as to form two handle segments 4 and two operating segments 5 of the first plier part 1 and the second plier part 2 (the operating segment 5 is clamp pliers or cut pliers, in this embodiment, the operating segment 5 is clamp pliers). The first plier part 1 includes a fixing mount 11 disposed on an inner surface of a handle segment 4 thereof adjacent to a connecting portion of the first plier part 1 and the second plier part 2, at least one guiding rail 12 formed on the fixing mount 11. The second plier part 2 includes a retaining seat 21 mounted on an inner surface of a handle segment 4 thereof proximate to the connecting portion of the first plier part 1 and the second plier part 2.

The slidable fastener 3 includes at least one guide protrusion 31 for slidably retaining with the at least one guiding rail 12 and includes a positioning rib 32 for limiting or releasing the retaining seat 21.

Thereby, after the slidable fastener 3 is slid, the positioning rib 32 corresponds to the retaining seat 21 so as to limit or release an expansion or a retraction of the first plier part 1 and the second plier 2, thus retracting and fixing the two operating segments 5 safely. In addition, the slidable fastener 3 is located at two inner surfaces of the two handle segments 4 adjacent to the connecting portion of the first plier part 1 and the second plier part 2, thereby pushing the slidable fastener 3 to release or limit the first plier part 1 and the second plier 2 easily.

Preferably, two guiding rails 12 are formed on two sides of the fixing mount 11, the slidable fastener 3 includes a hollow cavity defined between two inner walls thereof so as to retain the slidable fastener 3 with the fixing mount 11, and the slidable fastener 3 further includes two guide protrusions 31 formed on the two inner walls thereof so that the slidable fastener 3 retains with the fixing mount 11, and two outer walls of the slidable fastener 3 are higher than the two handle segments 4 so that user pushes the slidable fastener 3 easily.

Furthermore, the retaining seat 21 has two first bosses 211 arranged on two sides thereof, and the slidable fastener 3 further includes two locking ribs 33 formed on the two inner walls thereof so as to retain with the two first bosses 211, the retaining seat 21 also has a slot 212 defined between the two sides thereof so as to separate the two first bosses 211, such that the slidable fastener 3 is slid upwardly so that the two locking ribs 33 retain with the retaining seat 21, thus preventing the slidable fastener 3 from sliding.

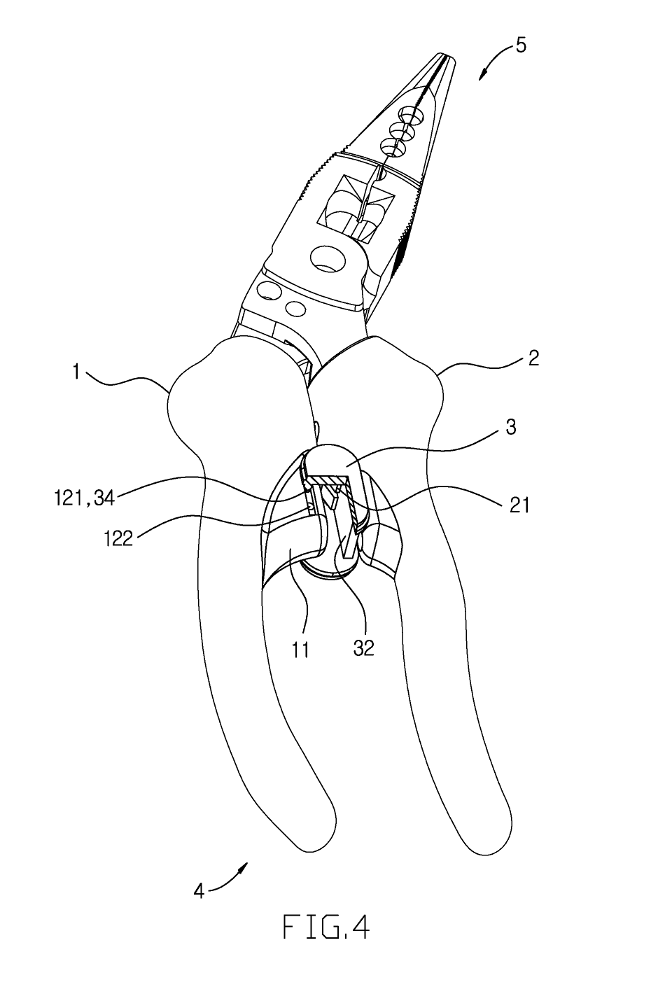

Preferably, each guiding rail 12 has a limiting recess 121 and a releasing recess 122 defined on an inner surface thereof, and each guide protrusion 31 has a second boss 34 for retaining with the limiting recess 121 or the releasing recess 122 (as shown in FIG. 4). For example, when the second boss 34 retains with the limiting recess 121, the retaining seat 21 engages with the positioning rib 32; and when the second boss 34 retains with the releasing recess 122, the retaining seat 21 disengages from the positioning rib 32, thus preventing the slidable fastener 3 from sliding.

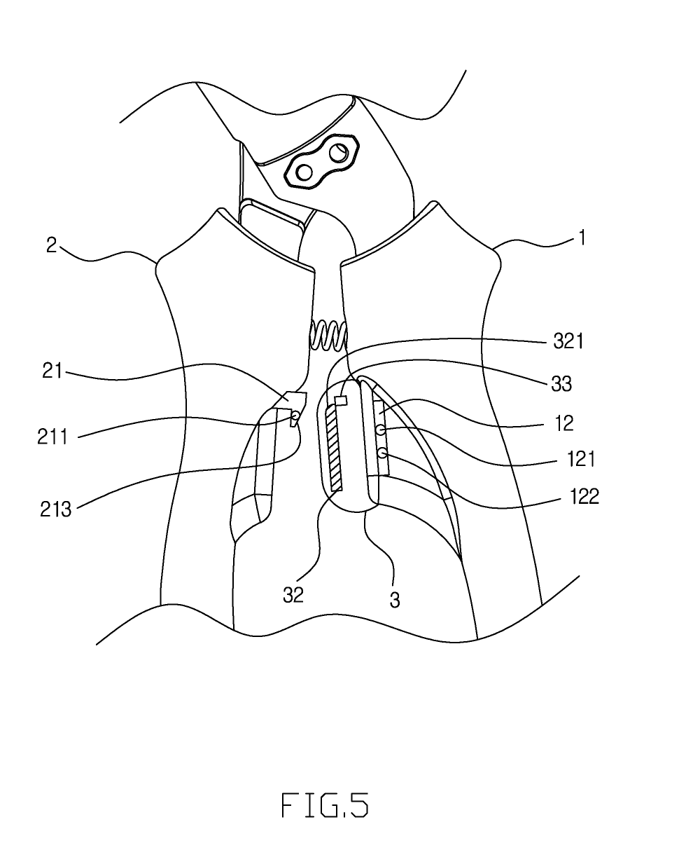

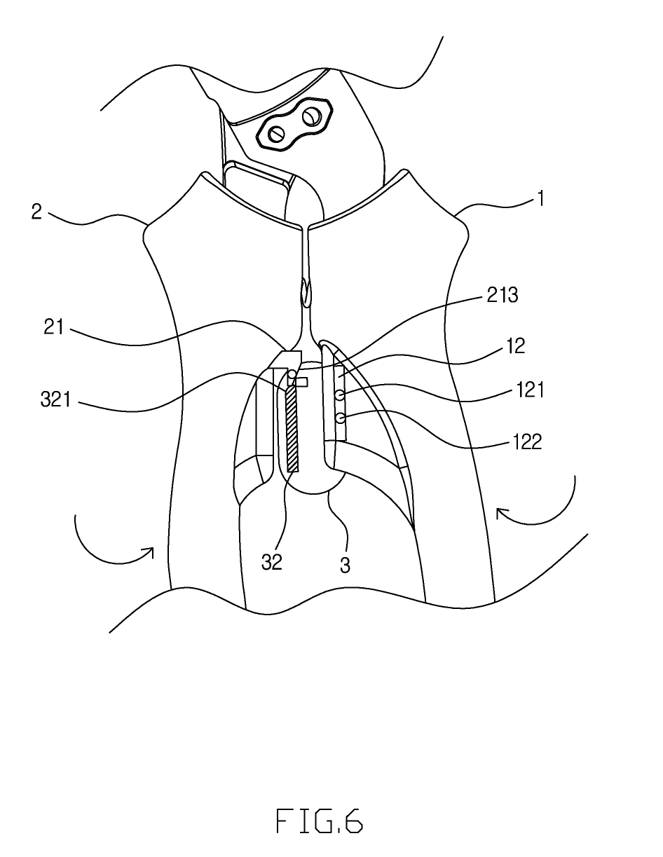

The retaining seat 21 further has a tilted face 213 defined on a bottom end thereof, and the positioning rib 32 has an arcuate face 321 formed on a top end thereof so as to be pushes by the tilted face 213 to drive the slidable fastener 3 to slide downwardly, such that when operating the pliers, the slidable fastener 3 slides to interfere the retaining seat 21 (i.e., when the slidable fastener 3 does not retain with the retaining seat 21 but corresponds to the retaining seat 21, as illustrated in FIG. 5), and after the pliers is pressed, the tilted face 213 and the arcuate face 321 force the slidable fastener 3 to remove backwardly, thereby preventing the slidable fastener 3 from interfering the pliers (as shown in FIG. 6).

Accordingly, the fastener structure of the present invention is provided with the slidable fastener 3 for releasing or limiting the expansion and the retraction of the first plier part 1 and the second plier 2, thus retracting and fixing the two operating segments 5 safely. Moreover, the two outer walls of the slidable fastener 3 are higher than the two handle segments 4 so that the user pushes the slidable fastener 3 easily to release or limit the pliers.

While the preferred embodiments of the invention have been set forth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A fastener structure for pliers comprising: a first plier part, a second plier part, and a slidable fastener;
the first plier part being pivotally connected with the second plier part so as to form two handle segments and two operating segments of the first plier part and the second plier part, the first plier part including a fixing mount disposed on an inner surface of a handle segment thereof adjacent to a connecting portion of the first plier part and the second plier part, at least one guiding rail formed on the fixing mount; the second plier part including a retaining seat mounted on an inner surface of a handle segment thereof proximate to the connecting portion of the first plier part and the second plier part;
the slidable fastener including at least one guide protrusion for slidably retaining with the at least one guiding rail, a positioning rib for limiting or releasing the retaining seat.

2. The fastener structure for the pliers as claimed in claim 1, wherein two guiding rails are formed on two sides of the fixing mount, the slidable fastener includes a hollow cavity defined between two inner walls thereof so as to retain the slidable fastener with the fixing mount, and the slidable fastener further includes two guide protrusions formed on the two inner walls thereof.

3. The fastener structure for the pliers as claimed in claim 2, wherein the retaining seat has two first bosses arranged on two sides thereof, and the slidable fastener further includes two locking ribs formed on the two inner walls thereof so as to retain with the two first bosses, the retaining seat also has a slot defined between the two sides thereof so as to separate the two first bosses.

4. The fastener structure for the pliers as claimed in claim 2, wherein each guiding rail has a limiting recess and a releasing recess defined on an inner surface thereof, and each guide protrusion has a second boss for retaining with the limiting recess or the releasing recess.

5. The fastener structure for the pliers as claimed in claim 2, wherein the retaining seat further has a tilted face defined on a bottom end thereof, and the positioning rib has an arcuate face formed on a top end thereof so as to be pushes by the tilted face to drive the slidable fastener to slide downwardly.
